(19) United States
(12) Patent Application Publication
(10) Pub. No.: US 2017/0330433 A1
(43) Pub. Date: Nov. 16, 2017

(54) INTELLIGENT HOME SECURITY AND MONITORING SYSTEM

(71) Applicant: Shou Qiang ZHU, Ontario, CA (US)

(72) Inventor: Shou Qiang ZHU, Ontario, CA (US)

(73) Assignee: IP POWER HOLDINGS LIMITED, Hong Kong (CN)

(21) Appl. No.: 15/594,478

(22) Filed: May 12, 2017

Related U.S. Application Data
(60) Provisional application No. 62/335,568, filed on May 12, 2016.

(51) Int. Cl. G08B 13/196; H04W 84/12

(52) U.S. Cl. CPC G08B 13/196; H04W 84/12

(57) ABSTRACT

A home security and monitoring apparatus may include a housing, an imaging capturing assembly, a communication unit, and a connecting portion. In an exemplary embodiment, the home monitoring apparatus is configured to attach to a bottom portion of a garage door opener. The image capturing assembly may include at least one camera to monitor preferably the situation of the garage. The communication unit is configured to communicate with an external device, such as a cell phone, by receiving signals therefrom and transmitting signals to the external device. In one embodiment, the communication unit may be wirelessly connected with the WIFI at home. The connecting portion may include at least one wire to electrically connect to the garage door opener, so the home monitoring apparatus can control the garage door opener to open/close the garage door when receiving an open-door command from an external device.

### CROSS-REFERENCE TO RELATED APPLICATIONS

This application claims priority under 35 U.S.C. §119 (e) to U.S. Provisional Patent Application Ser. No. 62/335,568, filed on May 12, 2016, the entire contents of which are hereby incorporated by reference.

### FIELD OF THE INVENTION

The present invention is directed to a system and method for home security and monitoring, and in particular to an intelligent home monitoring and security system.

### BACKGROUND OF THE INVENTION

With the rapid development of information and electronic technologies, various electronic or information products derived from a microprocessor are introduced continuously to bring tremendous convenience to people, which is indispensable to our daily life. As all kinds of information and electronic products are developed and improved continuously, intelligent home security systems have been incorporated with the electronic products to provide people an easier and more convenient way to control the electronic devices including lighting fixtures, air conditioning systems, garage doors, etc.

Home security is particularly important when the user needs to answer the doorbell, has small children, or is away from the home temporarily or for extended periods of time. Existing systems for viewing security content while in the home or at a remote location are often complex and unreliable. In many cases, a user may be required to use specialized security equipment that is not easily incorporated into a home environment. For example, the security system may require an exclusive data processing system and extensive wiring to function properly. In order to view security content, a user may be inconveniently required to go to a room designated for the voluminous amounts of security hardware. As a result, existing security systems are not easily integrated and do not allow efficient access to security content in or away from the home. In most cases, it is impossible to know conveniently when security content has been recorded in or away from the home. Most users cannot justify using a home security system with cameras based on the limitations and overall cost.

Therefore, there remains a need for a new and improved home security and monitoring system which can be easily incorporated to existing home electronic devices to overcome the problems presented above.

### SUMMARY OF THE INVENTION

It is an object of the present invention to provide an intelligent home security system that can be easily incorporated to existing home electronic devices.

It is another object of the present invention to provide an intelligent home security system that can be remotely controlled by the user's electronic devices, such as cell phone, tablet, computer, etc.

In one aspect, a home security and monitoring apparatus may include a housing, an imaging capturing assembly, a communication unit, and a connecting portion. In an exemplary embodiment, the home security and monitoring apparatus is configured to attach to a bottom portion of a garage door opener. In one embodiment, the home security and monitoring apparatus can be simply attached to the bottom of the garage door control unit by using stickers. In another embodiment, the home security and monitoring apparatus can be mechanically attached to the bottom of the garage door control unit.

The image capturing assembly may include at least one camera to monitor preferably the situation of the garage. The communication unit is configured to communicate with an external device, such as a cell phone, a computer, etc. by receiving signals therefrom and transmitting signals to the external device through a communication network. In one embodiment, the communication unit may be wirelessly connected with the communication network, e.g. WIFI, at home. The connecting portion may include at least one wire to electrically connect to the garage door opener, so the home security and monitoring apparatus can control the garage door opener to open/close the garage door, for example, when receiving an open-door command from the external device. In another embodiment, the user may have to download a software (“APP”) to the external device to control the garage door opener.

When in use, the home security and monitoring apparatus can be secured at the bottom portion of the garage door opener, so the cameras of the image capturing assembly can monitor the garage especially when the door is open or closed. Furthermore, the image captured by the image capturing assembly can be transmitted to the external device from the communication unit through the communication network. In one embodiment, when a mailman is trying to deliver something to the user's place, the user can remotely control the garage door to open to let the mailman get into the garage. The home security and monitoring apparatus may further include a microphone, and through the cameras of the image capturing assembly and the microphone, the user can even direct the mailman where to put the delivered items, and then remotely control the garage door to close after the mailman leaves.

In another embodiment, when a user is within a predetermined distance from home (e.g. within 0.5 mile), the cell phone can send out an open door command to the communication unit that can send out the open door command to the garage door opener through the wire of the connecting portion, so when the user arrives home, the garage door is already open for him/her.

### BRIEF DESCRIPTION OF THE DRAWINGS

FIG. 1 illustrates a schematic view of the intelligent home security apparatus in the present invention.

FIG. 2 illustrates a rear schematic view of the intelligent home security apparatus in the present invention.

FIG. 3 is a schematic view of the intelligent home security apparatus controlled by a mobile device in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

In order to further understand the goal, characteristics and effect of the present invention, a number of embodiments along with the drawings are illustrated as following:

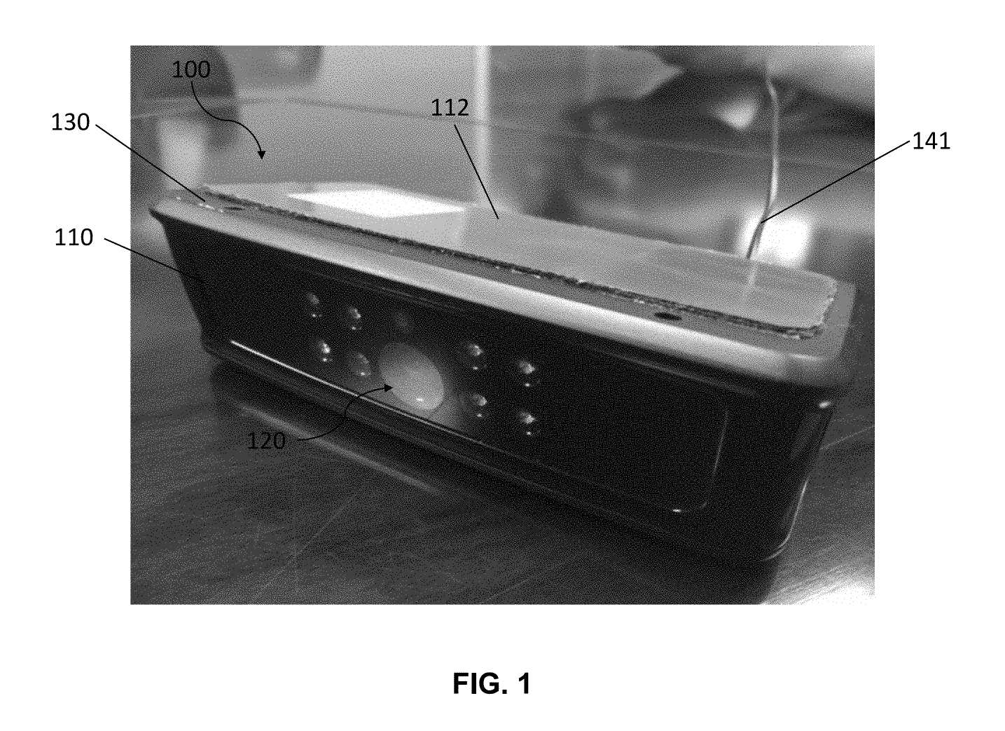

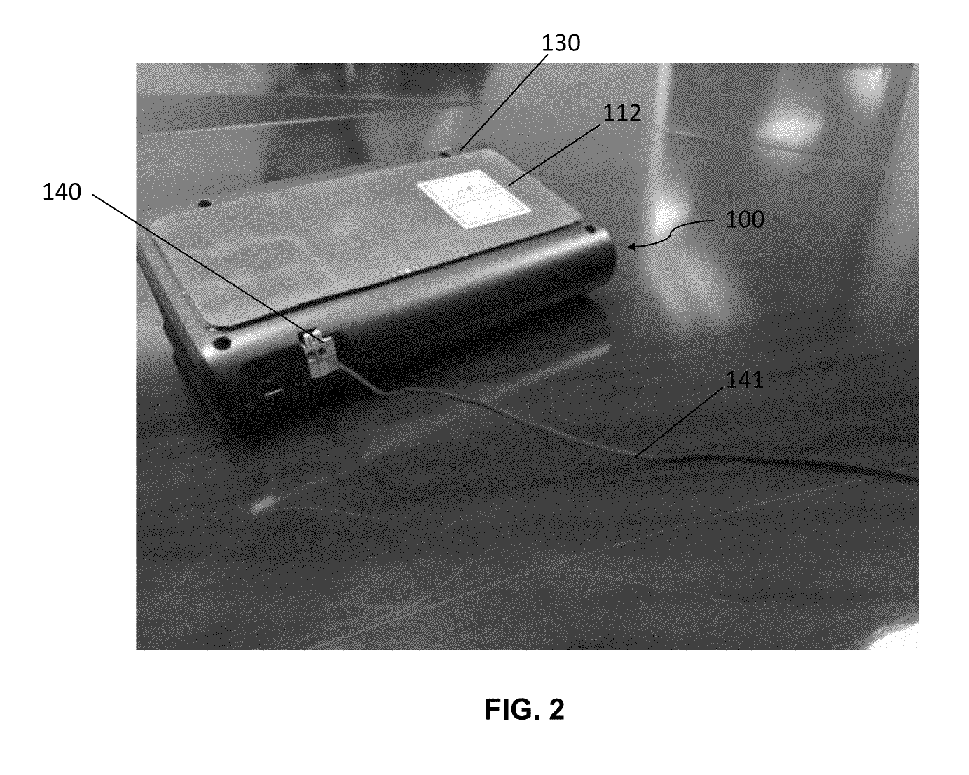

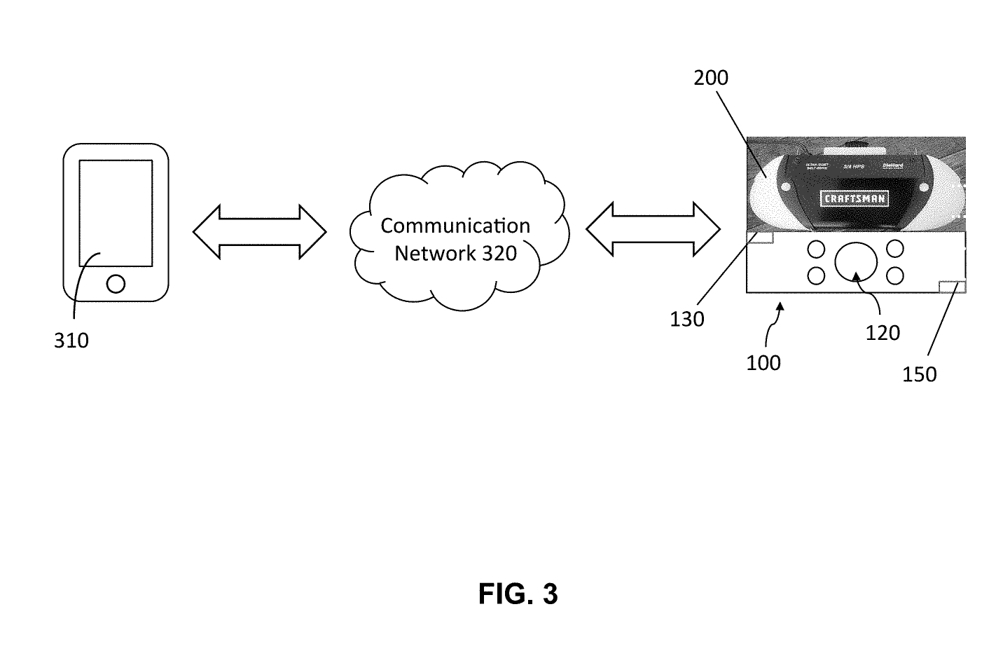

In one aspect, as shown in FIGS. 1 to 3, a home security and monitoring apparatus 100 may include a housing 110, an imaging capturing assembly 120, a communication unit 130, and a connecting portion 140. In an exemplary embodiment, the home security and monitoring apparatus 100 is configured to attach to a bottom portion of a garage door opener 200 (as shown in FIG. 3). In one embodiment, the home security and monitoring apparatus 100 can be simply attached to the bottom of the garage door control unit by using stickers. In another embodiment, the home security and monitoring apparatus 100 can be mechanically attached to the bottom of the garage door control unit.

The image capturing assembly 120 may include one or more cameras to monitor preferably the situation of the garage. The communication unit 130 is configured to communicate with an external device 310, such as a cell phone, a tablet, a computer, etc. by receiving signals therefrom and transmitting signals to the external device through a communication network 320. In one embodiment, the communication unit 130 may be wirelessly connected with the communication network, e.g. WIFI, at home. The connecting portion 140 may include at least one wire 141 to electrically connect to the garage door opener 200, so the home security and monitoring apparatus 100 can control the garage door opener 200 to open/close the garage door, for example, when receiving an open-door command from the external device 310. In another embodiment, the user may have to download a software (“APP”) to the external device 310 to control the garage door opener 200.

When in use, the home security and monitoring apparatus 100 can be secured at the bottom portion of the garage door opener 200, so the cameras of the image capturing assembly 120 can monitor the garage especially when the door is open or closed. Furthermore, the image captured by the image capturing assembly 120 can be transmitted to the external device 310 from the communication unit 130 through the communication network 320. In one embodiment, when a mailman is trying to deliver something to the user's place, the user can remotely control the garage door to open to let the mailman get into the garage. The home security and monitoring apparatus 100 may further include a microphone 150, and through the cameras of the image capturing assembly 120 and the microphone 150, the user can even direct the mailman where to put the delivered items, and then remotely control the garage door to close after the mailman leaves.

From time to time, there may be sad news that people hurt or even kill their child in or near the garage when the child was near the vehicle while the parent suddenly backs their cars out from the garage without noticing their child. With the home security and monitoring apparatus 100 in the present invention, the parent can monitor the surroundings in the garage and/or near the vehicle through their mobile device to make sure that the child is not near the vehicle to provide a safer environment to the child.

In another embodiment, when a user is within a predetermined distance from home (e.g. within 0.5 mile), the cell phone can send out an open door command to the communication unit 130 that can send out the open door command to the garage door opener 200 through the wire 141 of the connecting portion 140, so when the user arrives home, the garage door is already open for him/her.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A home security and monitoring apparatus comprising:
a housing;
an imaging capturing assembly comprising one or more cameras;
a communication unit configured to communicate with an external device by receiving signals therefrom and transmitting signals thereto through a communication network; and
a connecting portion having at least one wire to electrically connect to a garage door opener,
wherein the external device is configured to control an open/close position of the garage door through the communication unit and to monitor the garage through the imaging capturing assembly.

2. The home security and monitoring apparatus of claim 1, wherein the home security and monitoring apparatus is attached to a bottom portion of the garage opener.

3. The home security and monitoring apparatus of claim 1, wherein the external device is a mobile electronic device.

4. The home security and monitoring apparatus of claim 1, wherein the external device and the communication unit are communicated through WIFI.
